(19) United States
(12) Patent Application Publication
(10) Pub. No.: US 2026/0216960 A1
(43) Pub. Date: Jul. 30, 2026

(54) WELDING TOOL

(71) Applicant: ROPEX Industrie-Elektronik GmbH, Bietigheim-Bissingen (DE)

(72) Inventors: Maximilian Paul BAIER, Stuttgart (DE); Jürgen UTTENDORFER, Besigheim (DE)

(21) Appl. No.: 19/456,535

(22) Filed: Jan. 22, 2026

(30) Foreign Application Priority Data
Jan. 24, 2025 (EP) 25153753.6

(51) Int. Cl. B29C 65/22; B29C 65/00

(52) U.S. Cl. CPC B29C 65/224; B29C 66/8181; B29C 66/8187

(57) ABSTRACT

A welding tool for welding plastic films, with a carrier part, having a mechanical interface for coupling to a welding device and having a carrier surface on which a heating strip is arranged, which heating strip has a layer structure with a first electrical insulation layer, an electrically conductive heating layer and a second electrical insulation layer. The first electrical insulation layer is made of aluminum nitride.

### CROSS REFERENCE TO RELATED APPLICATION

This application claims priority to European Patent Application No. 25153753.6 filed January 24, 2025, which is incorporated by reference.

### BACKGROUND

The invention relates to a welding tool for welding plastic films.

EP 3241666 A1 discloses a heating device for thermally joining plastic materials, which has a base body that is intersected by a cooling recess and on which an electrically insulating carrier surface is formed, on which at least one electrically conductive heating conductor is arranged, which is provided with an electrically insulating coating on a contact surface facing away from the carrier surface, wherein the carrier surface has at least one curved or angled carrier surface section and wherein the heating conductor covers the curved or angled carrier surface section at least in some areas.

### SUMMARY

The objective of the invention is to provide a welding tool with which higher-quality welding seams can be produced.

This task is solved for a welding tool of the type as mentioned above, wherein the welding tool comprises a carrier part which has a mechanical interface for coupling to a welding device and has a carrier surface on which a heating strip is arranged, which heating strip has a layer structure with a first electrical insulation layer, an electrically conductive heating layer and a second electrical insulation layer, wherein the first electrical insulation layer is made of aluminum nitride.

It is preferably provided that the heating strip is a separate assembly that can be manufactured independently of the carrier part. Alternatively, it is provided that the heating strip is connected directly to the carrier surface of the carrier part during manufacture. For a direct connection between the heating strip and the carrier part, the first electrical insulation layer or the second electrical insulation layer is applied to the carrier surface in a material-locking manner, in order to then apply the further layers of the heating strip to the carrier part.

In this case, the heating strip has a layer structure based on the fact that the first insulation layer, which is made of aluminum nitride, is available as a dimensionally stable plate material and that the further layers of the layer structure are applied to this first insulation layer, preferably using ceramic thick-film technology, which means that the further layers are based on a paste like material which is applied to the first insulation layer and then hardened, in particular by heating the respective further layer as explained in more detail below. Alternatively, it is envisaged that the second insulation layer is first applied to the carrier part, and then the further layer structure for the heating strip is applied to this second insulation layer with the first insulation layer made of aluminum nitride as the top layer. It is preferred that the electrically conductive heating layer, the electrically conductive connection layer, and a second electrical insulation layer are each manufactured by means of ceramic thick-film technology. For example, the following layer is applied to the preceding layer from a formless ceramic mass (paste like material), in particular in a screen printing process or in a dosing process with a dosing nozzle or in a printing process based on inkjet printing. After applying the following layer, a curing process, in particular a sintering process, is carried out to solidify the typically paste-like amorphous ceramic mass and thus enable the application of the next layer.

Purely by way of example, it is envisaged that the first electrical insulation layer made of aluminum nitride has a dielectric strength greater than 15 kV, in particular 20 kV (kiloVolts).

Purely by way of example, it is envisaged that the electrically conductive heating layer has a specific resistance of 0.18 micro Ohms*m to 0.54 micro Ohms*m (Ohm*meter).

The mechanical interface formed on the carrier part enables the welding tool to be coupled to a welding device and can, for example, be made as a strip-shaped metal body made of aluminum or stainless steel or brass. The tasks of the carrier part are to ensure force transmission between the welding device and the heating strip and to cool the heating strip after a welding process has been carried out. The mechanical interface can, for example, be designed as a flat coupling surface with threaded holes so that the carrier part can be fixed to the welding device with screws.

Advantageous further developments of the invention are the subject of the subclaims.

It is advantageous if the first electrical insulation layer has a thickness in the range between 0.5 mm and 10 mm, preferably in the range between 1 mm and 5 mm. This ensures a favorable compromise between the amount of material required to produce the first electrical insulation layer and the electrical insulation properties of the first electrical insulation layer. For example, it is envisaged that the first electrical insulation layer is designed as a plane-parallel plate whose largest surface is designed as a rectangle. Preferably, it is envisaged that both a longer edge of this rectangle and a shorter edge of this rectangle are selected to be equal to or greater than the thickness of the first electrical insulation layer.

It is advantageous if the first electrical insulation layer is covered at least in some areas by at least one electrically conductive heating layer, preferably at least in some areas by at least two electrically conductive heating layers, in particular at least in some areas by at least three electrically conductive heating layers, wherein the respective electrically conductive heating layer is made of an electrically conductive ceramic material. Each of the electrically conductive heating layers has a maximum thickness depending on the manufacturing process for the electrically conductive heating layer, whereby a certain electrical resistance is established in view of the electrical properties of the material from which the electrically conductive heating layer is made and the geometry of the electrically conductive heating layer. In order to enable this electrical resistance to be adapted to the requirements of the welding tool, at least one further (second, third, …) electrically conductive heating layer can be applied to a first electrically conductive heating layer. Preferably this further electrically conductive heating layer completely, in particular congruently, or only partially, covers the first electrically conductive heating layer. It is assumed here that the adjacent electrically conductive heating layers do not exhibit any relevant contact resistance to each other and can practically be regarded as a common electrically conductive heating layer, which has been manufactured in separate steps. For example, it is envisaged that the at least one electrically conductive heating layer is applied as a strip to the first insulation layer, which is exemplarily designed in the form of a bar, whereby the width of the electrically conductive heating layer is selected to be smaller than the width of the first insulation layer.

In a further development of the invention, it is envisaged that at least one second electrical insulation layer made of an electrically insulating ceramic material is applied to the at least one electrically conductive heating layer. The function of the second electrical insulation layer is to prevent current flow between the underlying electrically conductive heating layer and the plastic films to be welded, or a counter tool provided for applying contact pressure to the plastic films to be welded. In addition, the second electrical insulation layer prevents the electrically conductive heating layer from coming into contact with oxygen from the atmosphere during operation, as this would destroy the electrically conductive heating layer within a relatively short time.

It is preferable that a glass coating is applied to the first electrical insulation layer and/or the second electrical insulation layer. The purpose of the glass coating is, in particular, to keep moisture away from the underlying layers of the heating strip. For this purpose, the glass coating provides a moisture-tight surface to prevent moisture from penetrating. For this purpose, the glass coating is applied to at least one surface of the first electrical insulation layer and/or the second electrical insulation layer facing away from the electrically conductive heating layer.

It is advantageous if a coating of a fluoropolymer or an inorganic polymer, in particular polysiloxane or polyorganosiloxane, is applied to the first electrical insulation layer and/or the second electrical insulation layer. With such a coating applied to at least one surface of the first electrical insulation layer and/or the second electrical insulation layer facing away from an electrically conductive heating layer, adhesion of the plastic film to the heating strip is at least largely prevented.

In one embodiment of the invention, an electrically conductive connection layer is provided between the first electrical insulation layer and the at least one electrically conductive heating layer or between at least two electrically conductive heating layers or between the at least one electrically conductive heating layer and the at least one second electrical insulation layer.

Purely by way of example, it is envisaged that the electrically conductive connection layer, which is made, for example, of silver or platinum or palladium with an admixture of ceramic components, has a specific resistance of less than 60 nano ohms*m (ohm*meter.

The electrically conductive connection layer serves to electrically connect the electrically conductive heating layer to a connection area of the welding tool, to which, for example, a connection cable can be connected. Typically, a connection area is formed at each of the opposite end areas of the electrically conductive heating layer, which is connection area is connected to the electrically conductive heating layer by means of the electrically conductive connection layer. Accordingly, the electrically conductive connection layer does not extend over the entire surface of the heating strip, but only over a fraction of the extent of this surface.

It is advantageous if the carrier part has a cooling channel that extends from a first coolant connection on the outer surface of the carrier part to a second coolant connection on the outer surface of the carrier part. The cooling channel is formed at least in some areas as a groove in the carrier surface, wherein the groove is bordered by a circumferential seal on which the heating strip rests in a sealing manner to close the cooling channel. The partial design of the cooling channel as a groove open in the direction of the heating strip ensures particularly intensive thermal interaction between the cooling liquid and the heating strip, as the cooling liquid comes into direct physical contact with the heating strip. Furthermore, the first electrical insulation layer made of aluminum nitride has a high thermal conductivity, so that rapid heat dissipation from the heating strip into the cooling liquid can be ensured after the welding process is completed. In order to prevent coolant from escaping from the cooling channel in the area of the open groove, the carrier part is provided with a circumferential seal, which in turn can be accommodated at least in some areas in a sealing groove that frames the open groove. Furthermore, it is provided that the heating strip is either connected to the carrier surface in a material-locking manner or is pressed onto the surrounding seal by suitable hold-down devices in areas away from the open groove.

Alternatively, it is provided that the cooling channel is closed, which can be realized with a bore in the carrier part, and thus there is no direct contact between the coolant and the heating strip. This can be achieved by drilling holes in the carrier part through which the coolant flows or by closing the cooling channel groove with a brass or aluminum cover. This ensures that the heating strip rests on the entire surface of the carrier part, thus keeping the risk of breakage of the heating strip low even in the event of locally acting force peaks.

In a further embodiment of the invention, the first electrical insulation layer is designed as a plane parallel plate and/or the largest surface area of the heating strip is larger than the carrier surface. Designing the first electrical insulation layer as a plane parallel plate is advantageous because aluminum nitride is difficult to machine and is usually manufactured in plate form. If the largest surface area of the heating strip is larger than the carrier surface, electrical contact can be made with the heating strip away from the welding surface of the heating strip, which is facing away from the carrier surface of the carrier part. This avoids the need for electrical connection elements that protrude above the welding surface and interfere with the welding process.

In an advantageous further development of the invention, it is envisaged that the at least one electrically conductive heating layer covers a flat surface of the first electrical insulation layer facing away from the carrier part in areas in order to form at least one local protrusion or elevation. Due to the high thermal conductivity of the first electrical insulation layer, the heat provided by the electrically conductive heating layer is distributed homogeneously over the entire surface of the first electrical insulation layer. In order to meet specific requirements with regard to the geometric design of the weld seam to be produced with the welding tool, it can therefore be provided that the electrically conductive heating layer only partially covers the first electrical insulation layer in order to achieve a narrower welding zone. Preferably, it is provided that due to the layer structure of the heating strip and, taking into account the deformation properties of the plastic films to be welded, it can be ensured during the welding process that only the areas of the electrically conductive heating layer that protrude from the first electrical insulation layer come into mechanical contact with the plastic films with the second electrical insulation layer applied thereto. It is also intended that there is no mechanical contact between those areas of the first electrical insulation layer that are not covered by the electrically conductive heating layer and the plastic film.

It is preferably provided that the first electrical insulation layer is structured in a relief-like manner on a surface facing away from the carrier part. Such structuring of the surface of the first electrical insulation layer can be achieved, for example, by manufacturing the first electrical insulation layer from several plate sections stacked on top of each other and structured differently in terms of geometry, or by machining, in particular by local milling. The electrically conductive heating layer or several electrically conductive heating layers can then be applied to one underside of the first electrical insulation layer, which is preferably flat, either covering only certain areas or covering the entire surface, and then the at least one second electrical insulation layer can be applied. When using such a heating strip, it is intended that the structured surface of the first electrical insulation layer is used for contact with the film to be welded and that the underside of the first electrical insulation layer faces the carrier part.

It is advantageous if a third electrical insulation layer, in particular one made of aluminum nitride, is arranged between two electrically conductive heating layers, forming a capacitor with the adjacent electrical heating layers. With such an electrical capacitor integrated into the electrical heating layer, zones with different heat development can be created in the heating strip, for example, since charging or discharging this capacitor results in locally different current distributions in the heating strip.

Alternatively, the electrical connection layer may be arranged on one side of the first insulation layer and the electrical heating layer on the other side of the first insulation layer so that the layers form a capacitor. The capacitor allows the alternating current with which the heating layer is operated to pass through the first insulation layer. In this way, the heating layer can be located on the side of the heating strip facing the film to be welded, and the electrical contact can be located on the side facing away from the film to be welded. This prevents the electrical contacts from coming into contact with the plastic film.

In a further embodiment of the invention, the first insulating layer is provided with an electrically conductive through-contact to contact the at least one electrically conductive heating layer. Such a through-contact enables the electrical contact, which previously protruded from the welding plane of the welding tool and was therefore disruptive, to be moved into a space away from the welding plane, where the electrical connection for the electrically conductive heating layer has no disruptive influence on the welding plane and the welding process. For this purpose, it is advantageous if the surface of the heating strip is larger than the carrier surface of the carrier part. It is preferable that the longest edge of the heating strip has a greater spatial extension than the longest edge of the carrier part, assuming that the longest edge of the heating strip is aligned parallel to the longest edge of the carrier part. The through-contact can be designed for a direct connection between an electrical connection cable and the electrically conductive heating layer without the need for an electrically conductive connection layer. Alternatively, the through-contact can be connected to an electrically conductive connection layer, which in turn is electrically connected to the electrically conductive heating layer.

### BRIEF DESCRIPTION OF THE DRAWINGS

Advantageous embodiments of the invention are shown in the drawing. Here,

FIG. 1 shows a purely schematic cross-sectional view of a welding tool with a carrier part and a heating strip,

FIG. 2 shows a connection area of the welding tool according to FIG. 1 with a layer structure of the heating strip, a through-contact, and an electrical connection cable,

FIG. 3 shows a purely schematic perspective view of a second embodiment of a welding tool with a relief-like surface, and

FIG. 4 shows a purely schematic perspective view of a heating strip on which a welding area and a separation area are formed.

### DETAILED DESCRIPTION

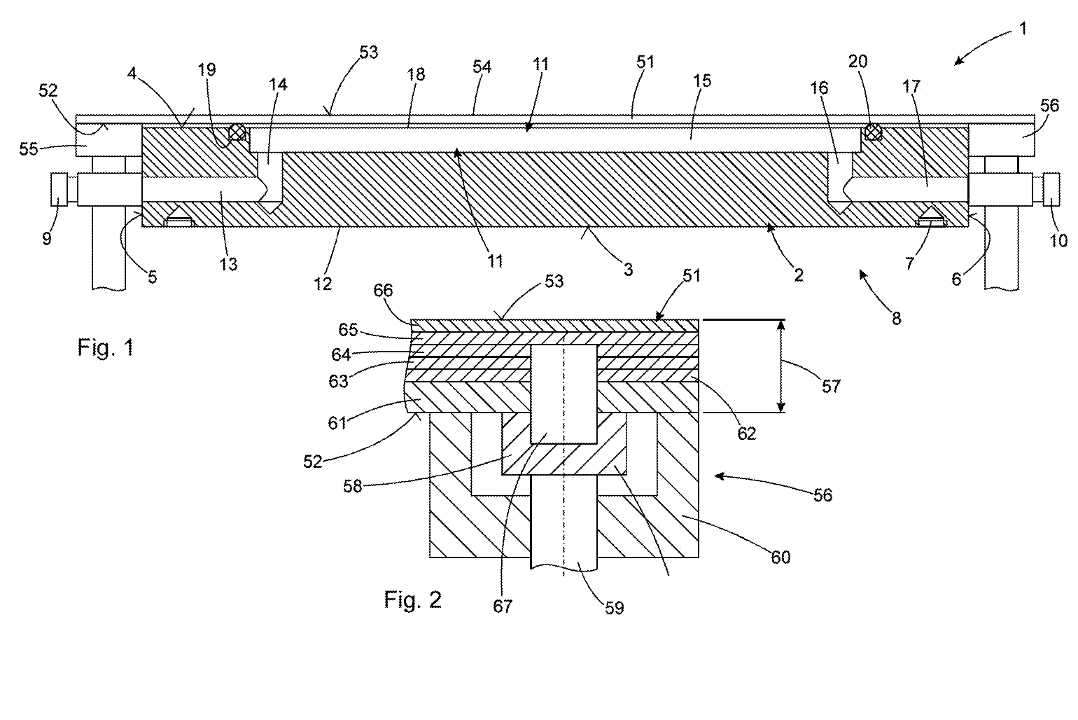

A welding tool 1 shown in FIG. 1 in a strictly schematic sectional view is intended for use in a welding system not shown and is used for welding plastic material, in particular plastic films.

The welding tool 1 comprises a carrier part 2 made, for example, of aluminum or stainless steel or brass or plastic, which can be designed in particular as a cuboid-shaped strip. Purely by way of example, the carrier part has a flat underside 3, a flat upper side 4 facing away from the underside 3, a left side surface 5, and a right side surface 6. Furthermore, the carrier part 2 has a rear side that is not visible in FIG. 1 and is aligned parallel to the plane of representation of FIG. 1, and a front side that faces the viewer of FIG. 1 and is also not visible due to the representation of FIG. 1.

Starting from the underside 3, two threaded holes 7 extend in the direction of the upper side 4, which, together with the underside 3, form a mechanical interface 8 for securing the carrier part 2 to the welding system. A first fluid connection 9 and a second fluid connection 10 are formed on the left side surface 5 and the right side surface 6, which are each provided purely as examples as hose couplings for connecting fluid hoses not shown and through which a cooling fluid, in particular cooling water, can be supplied to the welding tool 1 or removed from the welding tool 1.

Between the first fluid connection 9 and the second fluid connection 10, the distance between which is also determined by a longest edge 12 of the carrier part 2, a cooling channel 11 extends through the carrier part 2, which is formed purely by way of example by a first longitudinal bore 13 aligned parallel to the longest edge 12, a first transverse bore 14 aligned transversely to the longest edge 12, a groove 15, a second transverse bore 16, and a second longitudinal bore 17. By way of example, it is envisaged that the two longitudinal bores 13, 17 are each formed in the carrier part starting from the left side surface 5 and the right side surface 6, respectively. The groove 15 can, for example, be formed in the carrier part 2 by a milling process starting from the upper side 4. The transverse holes 14 and 16 can also be made in the carrier part 2 starting from the top side 4.

An opening 18 of the groove 15 is framed by a sealing groove 19, in which, purely by way of example, a circumferential, ring-shaped seal 20 is inserted. The sealing groove 19 and the seal 20 are matched to each other in such a way that the seal 20 protrudes beyond the upper side 4 of the carrier part 2 before the heating strip 51 is mounted on the carrier part 2. The seal 20 is preferably made of a rubber-elastic material whose elasticity properties are selected in such a way that, after the heating strip 51 has been mounted, the seal 20 rests sealingly against an underside 52 of the heating strip 51 and thus, in conjunction with the heating strip 51 and the carrier part 2, delimits a closed cooling channel 11 into which a fluid supply or fluid discharge is possible.

The heating strip 51 has, purely by way of example, the same extension as the carrier part 2 in a spatial direction aligned transversely to the plane of representation of FIG. 1. In contrast, the heating strip extends beyond the carrier part 2 on both sides in a spatial direction that is aligned parallel to the longest edge 12 of the carrier part 2. Due to the layer structure of the heating strip 51 described in more detail below, electrical contact of the heating strip is possible on the underside 52, so that the upper side of the heating strip 51 facing away from the underside 52, which can also be referred to as the welding surface, is free of interfering contours. This is particularly advantageous when using the welding tool 1 for welding processes in which the plastic material, in particular the plastic films, are conveyed in the direction of the longest axes 12, 54. For example, it is envisaged that the longest edge 54 has an extension of 0.05 m to 1 m and that the thickness 57 of the heating strip 51 is in the range of 2 mm to 10 mm.

As can be seen from the strictly schematic representation in FIG. 2, which shows a cross-sectional view of the second connection area 56 and an area of the heating strip 51, the heating strip 51 has a layer structure that is not shown to scale in FIG. 2. By way of example, the layer structure comprises a first insulating layer 61, a first electrically conductive heating layer 62, a second electrically conductive heating layer 63, a third electrically conductive heating layer 64, a second insulating layer 65, and an anti-adhesive layer 66. Purely by way of example, it is envisaged that all of the aforementioned layers of the layer structure, with the exception of the first insulating layer 61, have the same layer thickness, which is not necessarily the case in practice. The number of electrically conductive heating layers 62, 63, 64, the number of second insulation layers 65, and the number of anti-adhesive layers 66 may also be selected differently in practice.

The heating strip 51 is designed completely separately from the carrier part 2, as shown in FIG. 1, and can be manufactured independently of the carrier part 2. The heating strip 51 is fixed with its underside 52 to the upper side 4 of the carrier part 2 in a manner not shown, for example by gluing. Alternatively, it may be provided that mechanical fastening means not shown are used to fix the heating strip 51 to the carrier part 2.

To manufacture the heating strip 51, it may be provided that the first insulation layer 61 manufactured from aluminum nitride is first cut out of a plate-shaped raw material, for example by laser cutting, water jet cutting, or a cutting process like milling.

In a subsequent processing step, a purely exemplary circular cylindrical bore is made in the heating strip 51 starting from the underside 52 of the heating strip 51. An electrically conductive connection pin 67 is inserted into this circular cylindrical bore, which can be fixed in the bore, for example, by means of an electrically conductive adhesive.

The layers 62 to 65 are then applied individually, for example using a screen printing process, and cured. The anti-adhesive layer 66 is applied to the second insulation layer 65 by spraying and then cured.

The connection pin 67 thus forms a through-contact, which can be used to supply electrical energy to the electrically conductive heating layers 62 to 64 through the first insulation layer 61. Alternatively, the through-contact can also be created by filling the hole with an electrically conductive, amorphous mass, which is then cured.

For example, the connecting pin 67 protrudes downward beyond the underside 52 and is electrically connected to a connecting element 58. For example, the connecting element 58 is circularly cylindrical in shape, thus ensuring flat contact with the connecting pin 67. The connection element 58 is provided with a connection cable 59, which passes through an insulating sleeve 60 attached to the underside 52 of the heating strip 51.

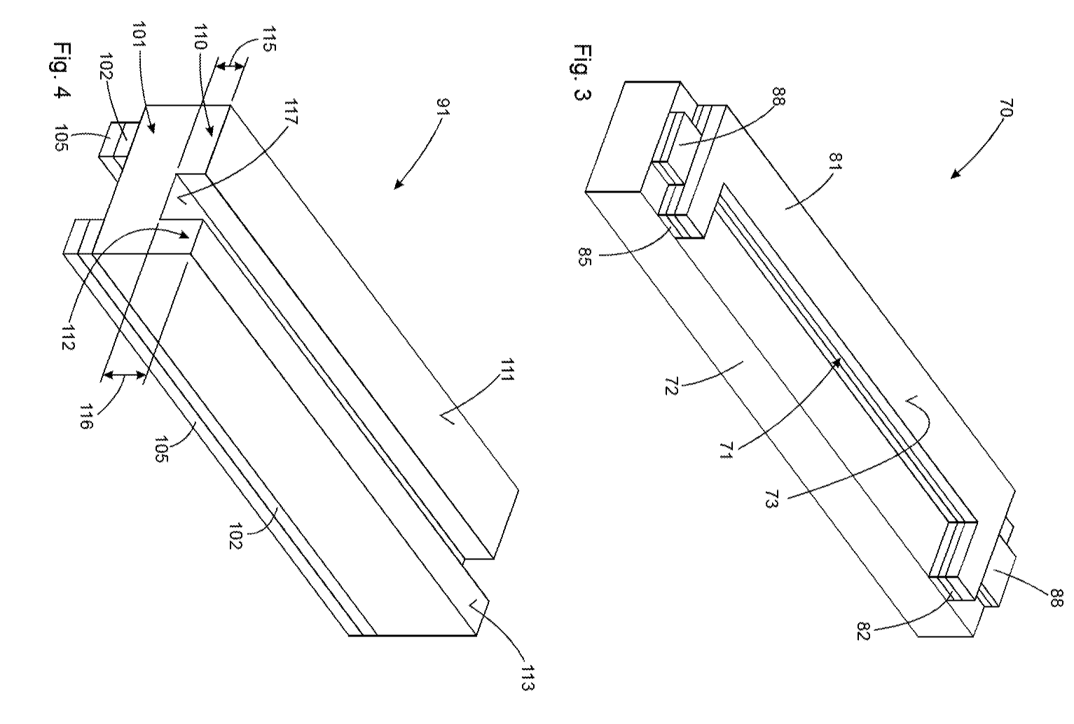

The second embodiment of a welding tool 70, shown only schematically in FIG. 3, comprises a carrier part 72 and a heating strip 71 resting on the carrier part 72. The heating strip 71 has a layered structure in which an upper side 73 of a first insulating layer 81 made of aluminum nitride is designed for mechanical contact and heat transfer with a plastic foil (not shown). Purely by way of example, the first insulating layer 81 is U-shaped in order to be able to produce a contour weld seam (not shown). A bottom side of the first insulating layer 81 is provided with an electrically conductive heating layer 82 and a second insulating layer 85, wherein the second insulating layer 85 rests on the electrically conductive carrier part 72.

For electrical contacting of the electrically conductive heating layer 82, electrically conductive connection areas 88, each designed in the manner of a conductor track, are provided on both sides, projecting laterally beyond the first electrical insulation layer 81, which can be connected in a manner not shown in detail to an electrical connection element in order to enable a current to flow through the electrically conductive heating layer 82.

The heating strip 91 shown in FIG. 4 has a strip-shaped profile body made of aluminum nitride, which forms the first insulation layer 101. The first insulation layer 101 has a welding area 110, which, purely by way of example, defines a rectangular welding surface 111. Adjacent to the welding area 110 is a separation area 112, which, purely by way of example, has a rectangular separation surface 113.

As can be seen from the schematic representation in FIG. 4, the separation area 112 is located at a greater distance 116 from a base surface 117 of the first insulation layer 101 than the welding area 110, which is located at a smaller distance 115 from the base surface 117. For example, it is provided that a heating strip 71 is arranged both below the welding area 110 and below the separation area 112.

The two heating strips 71, which are identical in structure purely by way of example, are each formed by an electrically conductive heating layer 102 and a second insulating layer 105 lying beneath it. In combination with the geometric design of the separation area 112, this allows a combined welding and separation process to be carried out with the heating strip 91, in which plastic films (not shown) can be welded to the welding area 110 and separated into individual sections by the adjacent separation area 112.

1. A welding tool for welding plastic films, with a carrier part, having a mechanical interface for coupling to a welding device and having a carrier surface on which a heating strip is arranged, which heating strip has a layer structure with a first electrical insulation layer, an electrically conductive heating layer, and a second electrical insulation layer, wherein the first electrical insulation layer is made of aluminum nitride.

2. The welding tool according to claim 1, wherein the first electrical insulation layer has a thickness in an interval between 0.5 mm and 10 mm.

3. The welding tool according to claim 1, wherein the first electrical insulation layer is covered at least partially by the electrically conductive heating layer, wherein the electrically conductive heating layer is made of an electrically conductive ceramic material.

4. The welding tool according to claim 1, wherein the second electrical insulation layer is made of an electrically insulating ceramic material and is applied to the electrically conductive heating layer.

5. The welding tool according to claim 1, wherein a glass coating is applied to the first electrical insulation layer and/or to the second electrical insulation layer.

6. The welding tool according to claim 1, wherein a coating made of a fluoropolymer or an inorganic polymer is applied to the first electrical insulation layer and/or to the second electrical insulation layer.

7. The welding tool according to claim 1, wherein an electrical conductive connection layer is located between the first electrical insulation layer and the electrically conductive heating layer or between two electrically conductive heating layers or between the electrically conductive heating layer and the second electrical insulation layer.

8. The welding tool according to claim 1, wherein the carrier part has a cooling channel which extends from a first coolant connection on the outer surface of the carrier part to a second coolant connection on the outer surface of the carrier part and which is formed at least in some areas as a groove in the carrier surface, wherein the groove is bordered by a circumferential seal on which the heating strip rests in a sealing manner.

9. The welding tool according to claim 1, wherein the first electrical insulation layer is formed as a plane-parallel plate and/or that a largest surface of the heating strip is larger than the carrier surface.

10. The welding tool according to claim 1, wherein the electrically conductive heating layer covers a flat surface of the first electrical insulation layer facing away from the carrier part in areas in order to form at least one local protrusion.

11. The welding tool according to claim 1, wherein the first electrical insulation layer has a relief-like structure on a surface facing away from the carrier part.

12. The welding tool according to claim 1, wherein a third electrical insulation layer is arranged between two electrically conductive heating layers to provide a capacitor in the heating strip.

13. The welding tool according to claim 1, wherein the first insulating layer is provided with an electrically conductive through-contact to contact the at least one electrically conductive heating layer.
